(19) United States
(12) Patent Application Publication
(10) Pub. No.: US 2024/0148606 A1
(43) Pub. Date: May 9, 2024

(54) APPARATUS FOR PROVIDING AUTOMATICALLY DOSED ACTIVITY

(71) Applicant: Vibetech, Inc., Sheboygan, WI (US)

(72) Inventor: Jeffrey Michael Leismer, Sheboygan, WI (US)

(21) Appl. No.: 17/980,434

(22) Filed: Nov. 3, 2022

(51) Int. Cl. A61H 23/02; A63F 13/285

(52) U.S. Cl. CPC A61H 23/0254; A63F 13/285; A61H 2201/164; A61H 2201/5005; A61H 2201/5043; A61H 2201/5058; A61H 2201/5082; A61H 2203/0431; A61H 2230/085

(57) ABSTRACT

An intelligent press machine, primarily for use with the legs, although the machine can also be used for upper body workouts. The intelligent press machine provides for varying resistance and vibration levels to stimulate muscle growth.

### FIELD OF THE INVENTION

The claimed invention relates to an apparatus and method for simulating physical activity. More specifically, the claimed invention relates to an intelligent press machine, primarily for use with the legs, although the machine can also be used for upper body workouts.

### BACKGROUND OF THE INVENTION

The present invention provides a method and apparatus for applying a therapeutic vibration to a person's arms or legs and in particular to an apparatus providing improved control of vibration and biasing force.

During periods of physical inactivity, the body “deconditions” at a rapid rate, a phenomenon known as disuse atrophy. In deconditioning, muscle fibers reduce in strength and size, muscles shorten and denervate, tendons and ligaments develop adhesions and permanently lose their flexibility resulting in loss of range of motion and bones may lose their strength. Such deconditioning can result in an increased fall injury risk and secondary complications such as obesity, cardiovascular disease, diabetes, and other life threatening ailments can arise.

Weight-bearing physical activity is the best known method for reducing or reversing disuse atrophy, but the underlying causes of disuse atrophy often limit one's ability to perform the necessary exercises.

Harness-based treadmills and aquatic therapy pools are capable of enabling persons with reduced mobility to perform physical activity under partial bodyweight loading. However, these modalities are costly to acquire, require significant space in a rehabilitation facility, are difficult to operate and may also be impractical for weakened individuals.

Electrical stimulation is an alternative means of inducing muscle activation in users who are unable to perform physical activity on their own. However, electrical muscle stimulation is site-specific, meaning it affects tissue(s) only in the vicinity of the electrode supplying electricity to the muscle, and it can cause discomfort and pain if used as a sole means to maintain muscle strength in the absence of physical activity.

An alternative to the above techniques is vibration therapy. Typical vibration therapy provides whole body vibration with the user standing on a vibrating platform. This also can be impractical for users with limited mobility. U.S. Pat. Nos. 7,662,115; 9,283,134; US patent publication 2012/0209156; US patent publication 2014/0276273 and US patent publication 2020/0046591 to the present inventor, each of which are hereby incorporated by reference, describe vibration therapy systems that may be applied to user limbs, such as the legs, with a recumbent or supine individual. What is additionally needed is an apparatus and method for providing automatically dosed therapeutic vibration to an individual.

### SUMMARY OF THE INVENTION

The present invention provides an improved system for applying therapeutic vibration to user limbs that allows electronic control of vibration, range of motion and biasing force applied to the limb. The invention permits a variety of therapy profiles to be implemented including those which vary bias force, vibration, and/or limb position in an exercise routine.

It is a feature of the claimed invention to provide for the motorized passive range of motion (“ROM”) of the limbs and trunk either together or independently both with and without vibration and with adjustment of speed, drive plate position, and duration.

It is an additional feature of the claimed invention to provide motorized passive range of motion plus therapeutic vibration with a single motor for generating range of motion and vibration with adjustment of the parameters in speed, drive plate position, and duration. Additionally, vibration frequency, amplitude, and waveform can be altered according to the claimed invention. Moreover, the claimed invention enables the bias force to be adjusted based on sensor input.

It is a further feature of the claimed invention that it is now possible to monitor and quantify the user's range of motion via drive plate position, strength and physiological response to vibration. A user's range of motion is approximated using drive plate travel distance during treatment. Strength is measured by measuring the force applied by a user using a load cell. Alternatively, strength may be measured by monitoring motor current draw. It should be noted that both mean and alternating force are measured. Mean force refers to the force a user is able to apply to the footplate. Mean force increases as the user exerts more pressure against the footplate. Alternating force refers to the force that is generated by the user that is resistant to the vibrations of the footplate. As vibrations are applied, they induce involuntary muscle contractions. These contractions, if sufficient in magnitude, can result in the user involuntarily pushing against the footplate, which results in a load cell being able to read a change in force of involuntary muscle force production.

The claimed invention further may include a built-in strength test, wherein the user is instructed to push against the drive plate as hard as they can or to hold a certain force for a set period of time. The force generate correlates to the user's strength. The claimed invention is further operable to measure isometric strength while the drive plate is stationary and isokinetic strength, wherein the drive plate is moving at a fixed speed. Additionally, the claimed invention is operable to measure strength following some other motion profile that we want the user to keep up with. This permits a caregiver to extrapolate an idea of the user's dynamic coordination.

Additional parameters including joint angle, energy consumed, electrodermal response and thermal response can be monitored and quantified. Joint angle is either measured or approximated by establishing the starting position of the body (e.g., legs are fully extended upon starting a treatment with the drive plate in the furthest position from the user and the finishing position when a user′ legs are fully retracted, joint angle can be estimated. Joint angle can also be measured using a goniometer or by using image or video analysis of at least 2 images taken at the extreme ends of travel.

Monitoring electrodermal activity is critical to patients with dementia to ensure that vulnerable individuals do not become anxious during a treatment. Electrodermal activity is measured with a skin conductance sensor. Skin conductance sensors detect the galvanic skin response. Generally speaking, a stressed or anxious person will have a decrease in electrical resistance at the measurement site (typically the palms of the hands, fingers, or soles of the feet, which detect this measure the best, but the electrode can be placed on other body sites as well). Electrodermal activity can be used it to tell if treatments are calming (resistance increases) or if instructions are confusing (resistance drops as stress increases). Thermal response can be measured using a thermal imaging camera or an array of thermocouples placed between the area of contact between the user and the drive plate.

The claimed invention further provides opportunities for a user to record information from user surveys that evaluate cognitive and physiological responses, such surveys including but not limited to pain scale, neuropathy symptoms and their intensity, measures of circulation, measures of function such as walking speed tests, range of motion, strength, and coordination, mood, energy level and physical confidence.

It is a further feature of the claimed invention to monitor the resistance used by the claimed invention, the position, range of motion and vibration frequency and wavelength. The claimed invention also employs a display that is operative to inform the user of all device data including protocol parameters, physiological measures and outcomes. Additionally, the claimed invention employs smart dosing of active ingredients of physical activity, whereby sensors are used to measure and monitor the device output, user's ability, subjective responses, and physiological responses and automatically adjust treatment parameters such as resistance, range of motion and vibration based on a predefined algorithm that aims to increase safety and efficacy for the user.

In accordance with the foregoing, the claimed invention provides a modular apparatus for providing dosed axial and vibratory force to the limb of a user of the apparatus, the limb having at least first and second segments each having axes and communicating by a joint, the modular apparatus comprising: a drive plate operable to receive the limb of a user; a force unit comprising a vibration system in communication with the drive plate to provide a vibration force to the drive plate and comprising an actuator assembly in communication with the drive plate and being operable to move the drive plate within an upper limit and a lower limit along an actuation axis that is perpendicular to the surface of the drive plate and generally the segment of the limb closest to the drive plate; at least one sensor operable to measure the physiological response of the user; and a controller in communication with the sensor and the force unit, the controller being operable to control the vibration motion and the actuator assembly in response to the physiological response of the user. The controller is operable to control the frequency, amplitude and waveform of vibration communicated via the drive plate. In another case, the sensor is a load sensor operable to detect the amount of axial resistance provided by a user and to communicate the amount of resistance to the controller which is operable to increase or decrease the axial force generated by the force unit. In yet an additional embodiment, the sensor is a load sensor operable to detect the amount of mean resistance to vibration provided by user and to communicate the amount of resistance to the controller which is in turn operable to increase or decrease the amplitude or frequency of the vibration or to change the waveform of the vibration.

Additionally, sensor could be a thermal sensor that is operable to detect the change in temperature of the user and to communicate the change in temperature of the user to the controller whereby the controller is operable to vary the axial or vibratory force supplied to the drive plate, or both. In yet an additional embodiment, the modular apparatus for providing dosed axial and vibratory force to the limb of a user of claim 1 wherein the sensor is an electrodermal sensor and the electrodermal sensor is in communication with the controller and the controller is operable to vary the axial or vibratory force supplied to the drive plate, or both. A further embodiment may include an actuator assembly is operable to vary the force required to move the drive plate and the speed at which the drive plate moves between the upper limit and a lower limit.

### BRIEF DESCRIPTION OF THE DRAWINGS

FIG. 1 is a back and side perspective view of the claimed invention in use with a wheelchair.

FIG. 2 is a side elevational view of the claimed invention in use with a wheelchair.

FIG. 3 is a back elevational view of the claimed invention when used with a wheelchair.

FIG. 4 is a top elevational view of the claimed invention when used with a wheelchair.

FIG. 5 is a left side elevational view of the claimed invention wherein the drive plate is nearly fully retracted.

FIG. 6 is a right side elevational view of the claimed invention wherein the drive plate is nearly fully extended.

FIG. 7 is a top side elevational view of the claimed invention.

FIG. 8 is a simplified diagram schematic view one embodiment of the vibration unit of the claimed invention.

FIG. 9 is a simplified diagram schematic view of another embodiment of the vibration unit of the claimed invention.

FIG. 10 is a left and front side perspective view of an embodiment of the vibration unit with addition of bolsters to fix the user's knee in place.

FIG. 11 is a right side elevational view of the claimed invention showing use of bolsters to hold the user's knee in place.

FIG. 12 is a perspective view of a controller used in connection with the claimed invention showing control adjustments as well as a force over time graph for a user.

### DETAILED DESCRIPTION

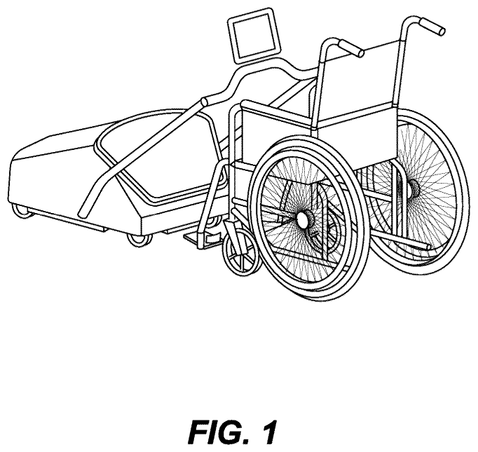

Now referring to the drawings in detail wherein like reference numerals refer to like elements throughout, FIG. 1 shows a force unit 22 that supports a textured drive plate 26. The drive plate 26 a is positioned to receive the feet of the user on a support surface 27 when the user is positioned in a seat 12 with his or her feet slightly elevated with bent knees. In this respect, the top of the drive plate 26 may angle away from the user by about 30 degrees from vertical. Pressure by the feet and legs of the user against the drive plate 26 is resisted by the user's seat and back support 16.

The force unit 22 comprises an actuator assembly 28 communicating with the drive plate 26 to impart a vibration motion 30 to the drive plate 26 along an actuation axis 34 generally normal to the support surface 27 of the drive plate 26 and aligned with the lower leg of the user. The vibration motion 30 may impart time-varying oscillations to the drive plate 26 at a temporal frequency which may be periodic or random. The oscillations may have a response magnitude defined by an excursion range about an equilibrium point that is less than the magnitude generally needed to compress the muscles of the legs. In one embodiment, the vibration motion 30 may be provided by a vibrating motor (e.g., eccentric rotating mass vibration motor (ERM)) communicating with the drive plate 26. In an alternative embodiment, the vibration motion 30 may be provided by a pump that when pressed initiates spinning of a rotational component with an off-center mass. Spinning of the eccentrically-weighted rotational component causes vibration motion 30 which is translated to the pump and the drive plate 26. The pump may be pressed by applying a force on the drive plate 26, for example, by the user's feet applying force to the drive plate 26. The pump may be adapter 31 or a part of plate adapter 31.

The force unit 22 further comprises an actuator assembly 28 communicating with the vibration surface 26 to impart a bias motion 32 to the vibration surface along an actuation axis 34 generally normal to the surface of the vibration surface 26 and aligned with the lower leg of the user 11. The floor support 23 may provide angulation to the force unit 22 to provide the desired angle of the actuation axis 34.

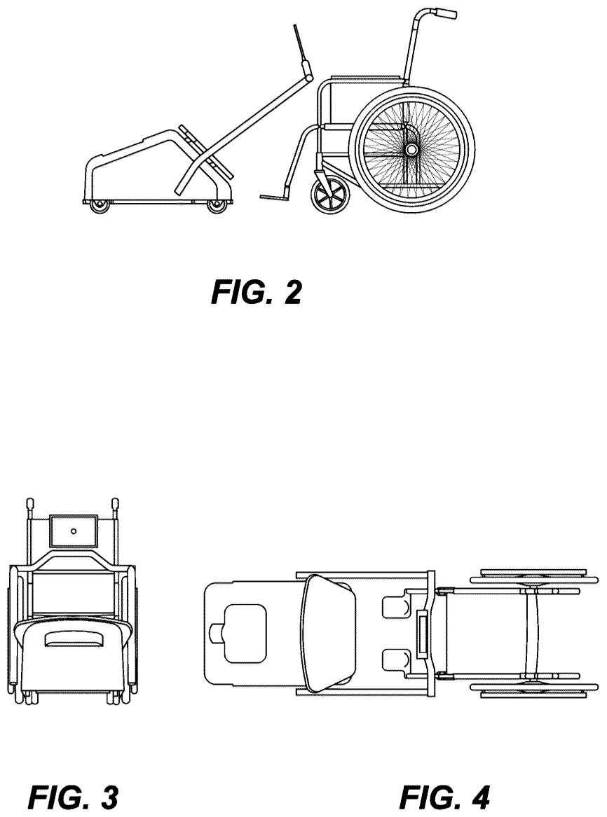

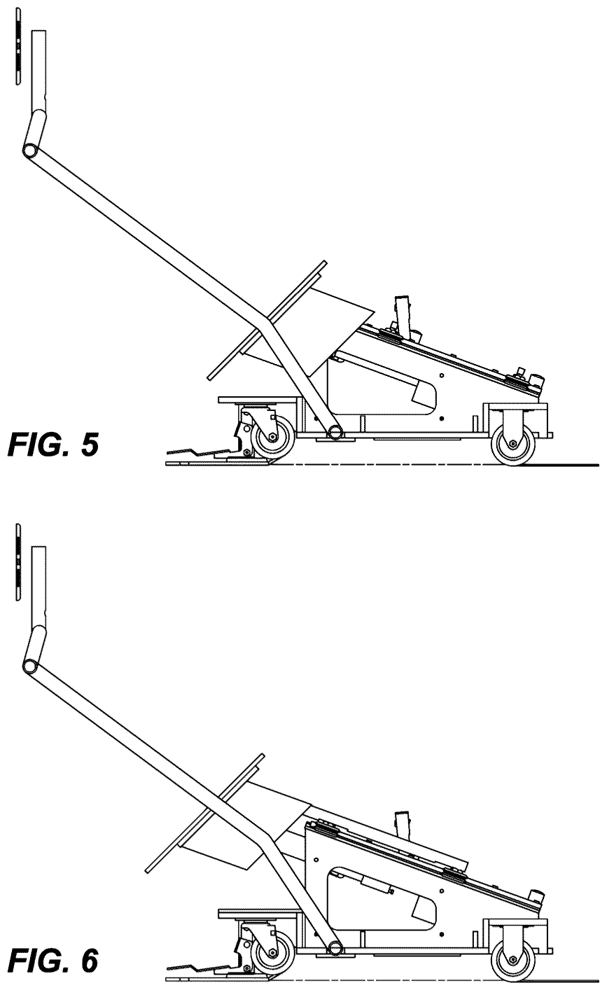

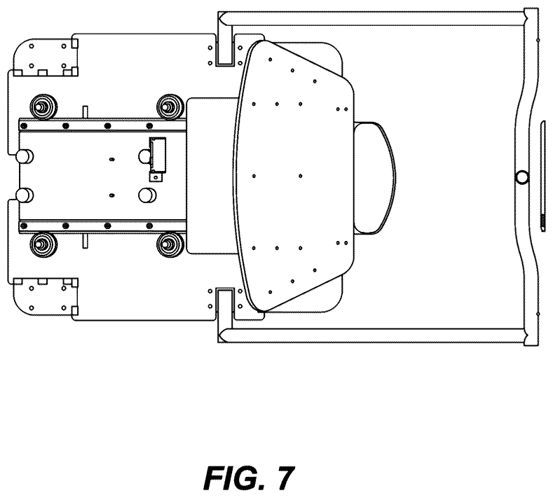

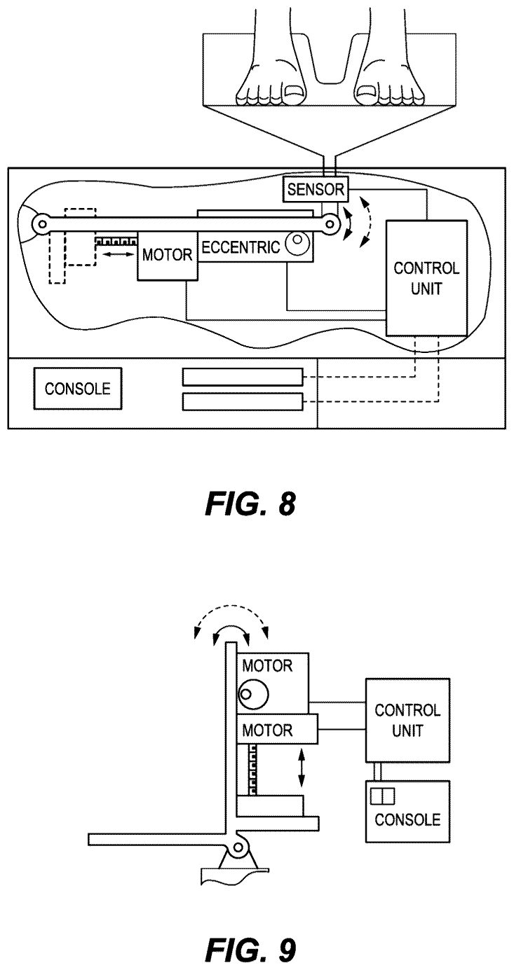

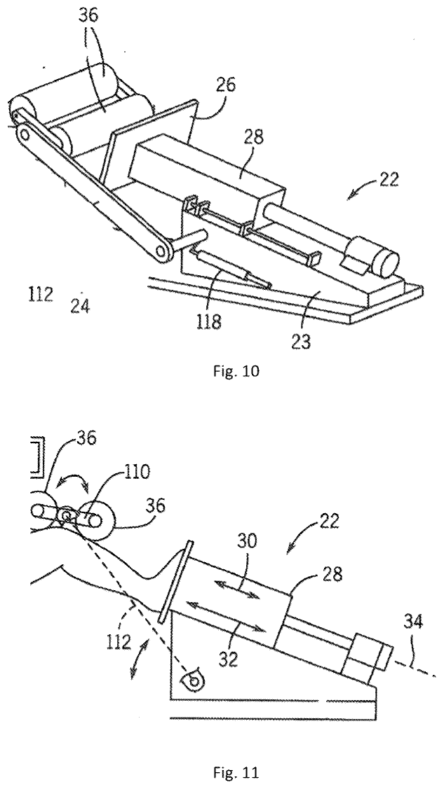

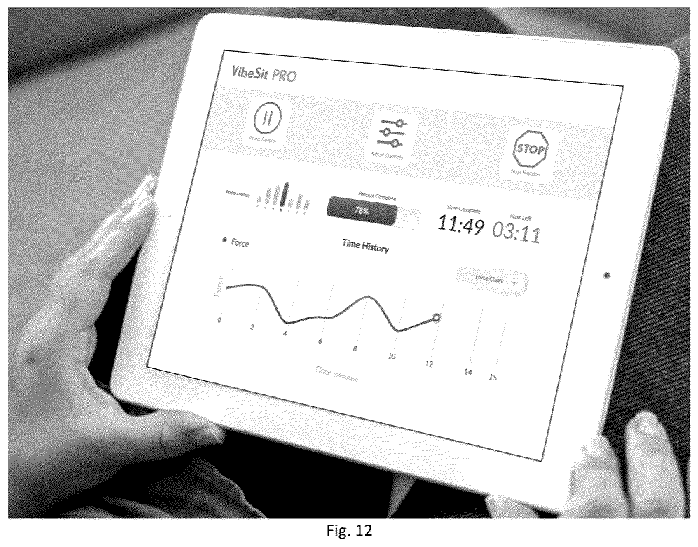

Referring now to FIGS. 1 and 2, bolsters 54 may be generally padded cylinders extending across actuation axis 34 to fit on either side of the knees as separated by an equalizer arm 56. The equalizer arm 56 extending between the bolsters 54 may pivot at a pivot 58 midway along the equalizer arm 56 and join the equalizer arm 56 to one and of a swing arm 60. The swing arm 60 may communicate to its opposite end with the connecting structure 24 through a second pivot 62. In this way, the bolsters 54 may be moved down against the knees of the user by downward rotation of the swing arm 60 with rotation of the bolsters 54 about the pivot 58 equalizing force above and below the knees of the user. Alternatively, the swing arm 60 may be moved upward to move the bolsters 54 away from the knees of the user to allow the user to freely exit the device 10. In one embodiment of the present invention, the swing arm is not attached to the connecting structure 24 but is a free-standing structure that is supported on the floor 74 by locking rollers that allow the bolsters 54 to be rolled to the desired location but is not fixed to the device 10.

The force unit 22 may also support a device arm 64 supporting a user interface 66, for example, providing a touchscreen for receiving commands from the user and providing a display to the user. It is understood that the commands may also be received through physical buttons or virtual buttons shown on the user interface 66.

The various components of the device 10 may be controlled by a controller 77 providing one or more electronic computer 78 processors communicating with electronic memory 80 for storing a program 82 to be executed by the electronic computer 78 according to data and the program 82 in the memory 80. The memory 80 provides a non-transient storage medium for the program 82.

The controller 77 may communicate with the user interface 66, the actuator assembly 28, and the restoring element 37 for electronically controlling the vibration motion 30 and restoring force 32. For example, the controller 77 may operate to change the vibration motion 30 and restoring force 32 depending on the operating program 82 to provide strength assessments, range of motion assessments, and other assessments. For example, the operating program 82 may monitor the amount of forward force 40 acting on the drive plate 26 and provide feedback to the patient, therapist, or other third party through the user interface 66 or other monitor to show force versus time for varying amounts of vibration motion 30 and restoring force 32. In another example, the patient is instructed to maintain a constant forward force 40 as the amounts of vibration motion 30 and restoring force 32 applied changes. The amount of forward force 40 applied by the user may be indicated on the user interface 66. A score is provided to the user at the end of the session. In another example, the operating program 82 may monitor the amount of movement 32 of the drive plate 26 a and provide feedback to the patient, therapist, or other third party through the user interface 66 or other monitor to show the range of motion of the user's limb and the restoring force 32 as a function of range of motion.

The program 82 may further provide instructions to the user interface 66 in order to communicate passive range of motion exercises, active exercises, cognitive exercises, team competitive and collaborative exercises, remote competitive and collaborative exercises to the user in connection with use of the device 10. The program 82 may also provide assessment tools such as range of motion testing (via stepper motor count), strength testing (via load cell), circulation testing (via thermal imaging), stress testing (via skin conductance), cognitive testing (via on-screen assessments), and vibro-tactile sensation testing. Other programs 82 may include educational and training software and service and maintenance programs 82.

Results of the program 82 may be reported to the user and/or outside third parties customized to each particular user. Third parties receiving the reporting information may use the information to gather global data, make comparisons between users, and assess the progress of the user. Results of the program 82 may also be communicated through social media.

References to “a controller” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

In operation, the claimed invention can operate in one of several therapeutic modes. Specifically, the claimed invention can operate as a passive range of motion machine. In such cases, the speed of the drive plate and the range of motion of the drive plate are adjustable. The claimed invention may also operate as a passive range of motion machine with the added feature of vibration, the vibration being adjustable for frequency, amplitude and waveform.

In addition to its usefulness as a passive range of motion machine, the claimed invention is also useful for resistance training. As when used as a passive range of motion machine, the speed of speed of the drive plate and the range of motion of the drive plate are adjustable. Vibration can be an added feature, and is adjustable for frequency, amplitude and waveform. The claimed invention further includes a plurality of sensors that measure drive plate position, joint angle, mean and alternating forces, energy consumed, electodermal response, temperature. Additional measurements include the resistance offered by the user. The claimed invention further provides a display of parameters available to a user.

The claimed invention further includes the ability to establish and/or recommend dosing parameters based on input established from user data based on their ability, the user's subjective response, or the user's physiological response to treatment or other stimuli (e.g., walking, biking, electrical stimulation, passive range of motion, etc.).

The claimed invention further provides for “smart” dosing of the active ingredients of physical activity. Sensors measure and monitor the force unit's output, user's ability, the user's subjective responses, and the user's physiological responses and automatically adjust treatment parameters including resistance, position, range of motion and vibration) based on a predefined algorithm that aims to increase safety and efficacy for the user. An example of Smart Dosing in operation is as follows. During a therapeutic session, if a user does not have their feet on the drive plate 26, the load cell detects that there is no force acting against the drive plate 26, and that triggers a command to be sent to the motor which extends the drive plate 26 towards the user at a predetermined speed. Once the limit switch detects that the drive plate has reached its most extended position, a signal is sent to tell the motor to stop. The resting weight of the limb (or trunk) against the drive plate overcomes a threshold force required to make the footplate move (15 lbs is the default threshold). As the drive plate detects a force beyond the minimum threshold to cause it to move, it moves proportionally to the amount of force measured up to the maximum displacement (when the drive plate is fully retracted). It achieves this position during treatment at 100 lbs (by default, but this can be adjusted). While the force and position are linearly related for the real-time autodosing protocol that is the device's current default protocol, these parameters can be set to be nonlinear. For example, if during a repetition through the full range of motion of the footplate it was desired to have it feel as if the user is pushing the drive plate over a series of bumps, we can prescribe an equation that simulates such a force vs position curve. Likewise, through monitoring of one or more of the load sensor, thermal sensor, transdermal sensor, it may become apparent that the user is experiencing fatigue in which case, the claimed invention may reduce the intensity required to push the footplate, the range of motion, or reduce the intensity of vibration. Alternatively, monitoring one or more of the load sensor, thermal sensor, or transdermal sensor may reveal that the user would be benefited by increased vibration, axial load or range of motion, which would thereby automatically be increased.

The claimed invention also permits the gamification of workouts via a gaming application installed on the controller or in electronic communication with the controller. More particularly, the claimed invention will use the mechanical force that an individual places onto the footplate of the claimed invention to relay a real time signal to a gaming application that would take that specific input signal and display an in-game output. The gaming application could have different features that relate to a specific vibrational setting of the claimed invention. Thus, the gaming application could be used as a means to make the activity of applying force on the footplate of the claimed invention more fun and engaging. For example, one possible game could be a helicopter game. In the exemplary helicopter game, the helicopter is used to correlate with the physical exercise of the user attempting to maintain a specific amount of pressure on the drive plate. The amount of pressure applied to the drive plate corresponds to how high the helicopter flies. The object of the game is to fly the helicopter through a tunnel that moves upwardly and downwardly. As the tunnel moves up and down, the user is required to maneuver the helicopter up and down and the user is therefore required to apply both more pressure and less pressure at times, in a slow and controlled manner, in order to safely navigate the helicopter through the tunnel and increase their score. The game will also correlate the cognitive functions of spatial recognition and peripheral awareness, potentially allowing patients to stimulate the brain in a rehabilitative manner.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What is claimed is:

1. An apparatus for providing dosed axial and vibratory force to the limb of a user of the apparatus, the limb having at least first and second segments each having axes and communicating by a joint, the modular apparatus comprising:
a drive plate operable to receive the limb of a user
a force unit comprising a vibration system in communication with the drive plate to provide a vibration force to the drive plate and comprising an actuator assembly in communication with the drive plate and being operable to move the drive plate within an upper limit and a lower limit along an actuation axis that is perpendicular to the surface of the drive plate and generally the segment of the limb closest to the drive plate;
at least one sensor operable to measure the physiological response of the user; and
a controller in communication with the sensor and the force unit, the controller being operable to control the vibration motion and the actuator assembly in response to the physiological response of the user.

2. The apparatus for providing dosed axial and vibratory force to the limb of a user of claim 1 wherein the controller is operable to alter the upper limit or the lower limit of the drive plate in response to an input from the at least one sensor.

3. The apparatus for providing dosed axial and vibratory force to the limb of a user of claim 1 wherein the controller is operable to control the frequency, amplitude and waveform of vibration communicated via the drive plate.

4. The apparatus for providing dosed axial and vibratory force to the limb of a user of claim 1 wherein the sensor is a load sensor operable to detect the amount of axial resistance provided by a user and to communicate the amount of resistance provided by a user to the controller.

5. The apparatus for providing dosed axial and vibratory force to the limb of a user of claim 1 wherein the sensor is a load sensor operable to detect the amount of mean resistance to vibration provided by user and to communicate the amount of resistance provided by a user to the controller.

6. The apparatus for providing dosed axial and vibratory force to the limb of a user of claim 1 wherein the sensor is a load sensor operable to detect the amount of axial resistance provided by a user and to communicate the amount of resistance to the controller which is operable to increase or decrease the axial force generated by the force unit.

7. The apparatus for providing dosed axial and vibratory force to the limb of a user of claim 1 wherein the sensor is a load sensor operable to detect the amount of mean resistance to vibration provided by user and to communicate the amount of resistance to the controller which is in turn operable to increase or decrease the amplitude or frequency of the vibration or to change the waveform of the vibration.

8. The apparatus for providing dosed axial and vibratory force to the limb of a user of claim 1 wherein the sensor is a thermal sensor operable to detect the change in temperature of the user and to communicate the change in temperature of the user to the controller.

9. The apparatus for providing dosed axial and vibratory force to the limb of a user of claim 1 wherein the sensor is a thermal sensor operable to detect the change in temperature of the user and to communicate the change in temperature of the user to the controller and the controller is operable to vary the axial or vibratory force supplied to the drive plate, or both.

10. The apparatus for providing dosed axial and vibratory force to the limb of a user of claim 1 wherein the sensor is a thermal sensor operable to detect the change in temperature of the user and to communicate the change in temperature of the user to the controller.

11. The apparatus for providing dosed axial and vibratory force to the limb of a user of claim 1 wherein the actuator assembly in communication with the drive plate is operable to adjust the bias force applied via the drive plate between the upper and lower limit.

12. The apparatus for providing dosed axial and vibratory force to the limb of a user of claim 1 wherein the sensor is an electrodermal sensor and the electrodermal sensor is in communication with the controller and the controller is operable to vary the axial or vibratory force supplied to the drive plate, or both.

13. The apparatus for providing dosed axial and vibratory force to the limb of a user of claim 1 wherein the actuator assembly is operable to vary the force required to move the drive plate between the upper limit and a lower limit.

14. The apparatus for providing dosed axial and vibratory force to the limb of a user of claim 1 wherein the actuator assembly is operable to vary the force required to move the drive plate and the speed at which the drive plate moves between the upper limit and a lower limit.

15. The apparatus for providing dosed axial and vibratory force to the limb of a user of claim 1 wherein the controller further comprises a gaming application and the gaming application operable to use the mechanical force that an individual places onto the footplate of the claimed invention to relay a real time input signal to the gaming application that would take the real time input signal and display an in-game output response.
